(19) United States
(12) Patent Application Publication
(10) Pub. No.: US 2008/0224579 A1
(43) Pub. Date: Sep. 18, 2008

(54) Modular storage system

(76) Inventor: Robert Juten, Duluth, MN (US)

Correspondence Address: DARBY & DARBY P.C., P.O. BOX 770, Church Street Station, New York, NY, 10008-0770, US

(21) Appl. No.: 11/407,710

(22) Filed: Apr. 19, 2006

Related U.S. Application Data
(60) Provisional application No. 60/673,009, filed on Apr. 19, 2005.

(51) Int. Cl. F16B 12/00

(52) U.S. Cl. 312/111

(57) ABSTRACT

A modular storage system comprising one or more rails that are substantially horizontally attached to a support structure and one or more storage components that are coupled to one or more of the rails such that the storage components can be repositioned along the rails. The storage components may comprise a vertical partition, a cabinet, a drawer unit, a shelving unit, and the like. The storage component may be installed between sidewalls along with shelves, dowels, or other horizontal units. A top, bottom, and/or rear panel can also be coupled to the sidewalls and/or rails to make an enclosed unit. The storage components include a notch or recess to fit over the rails so that a back portion will fit flush with a surface of the support structure. Couplers can be adjusted to tighten and loosen the storage components to the rails for easy repositioning.

### CROSS-REFERENCE TO RELATED APPLICATIONS

This utility application claims the benefit of U.S. Provisional Patent Application 60/673,009 filed Apr. 19, 2005; the contents of which are hereby incorporated by reference.

### FIELD OF ART

The present invention is generally directed to a modular storage system, and more particularly to prefabricated components that can be coupled to one or more horizontal rails and repositioned on the horizontal rails.

### BACKGROUND

A number of shelving and storage kits are available for consumer or professional installation. Some of these kits include prefabricated components such as shelves, cabinets, drawers, and clothes hanger rods. The prefabricated components are generally designed for installation at predefined locations relative to each other and not intended for repositioning. The components are typically attached to structural frame members of a building that are behind a wall board. Other kits include vertical rails that are attached to the structural frame members, and enable some components, such as shelves, to be vertically repositioned. However, the components generally have fixed horizontal dimensions and can not be horizontally repositioned.

### BRIEF DESCRIPTION OF THE DRAWINGS

FIG. 1A is a transparent isometric view of an exemplary embodiment of a modular storage system that illustrates a moveable partition that is coupled to horizontal rails;

FIG. 1B is a magnified view of an area at which a partition interfaces with a ceiling;

FIG. 1C is a magnified view of an area at which a partition couples to a railing;

FIG. 2A is a side view of another embodiment that couples a partition to a surface such as a wall board;

FIG. 2B is an exploded view showing an exemplary coupling that couples a partition into contact with a surface; and

FIG. 3 is a transparent isometric view of another exemplary embodiment that includes a moveable drawer unit that is coupled to horizontal rails.

### DETAILED DESCRIPTION

The present invention provides a hybrid approach to building construction that may utilize design and manufacturing automation, simplify installation, and enable users to add and/or adjust internal components. Modular storage systems and other internal spaces conforming to the present invention may be designed with customer input, and components may be produced with automation techniques. The components may be delivered to and assembled at a building site for stand alone use or may be attached to structural frame elements to provide a storage system that is integrated with other internal spaces. Installers and/or end users may also modify the configuration and/or location of components as desired.

### Exemplary Embodiment—Partition

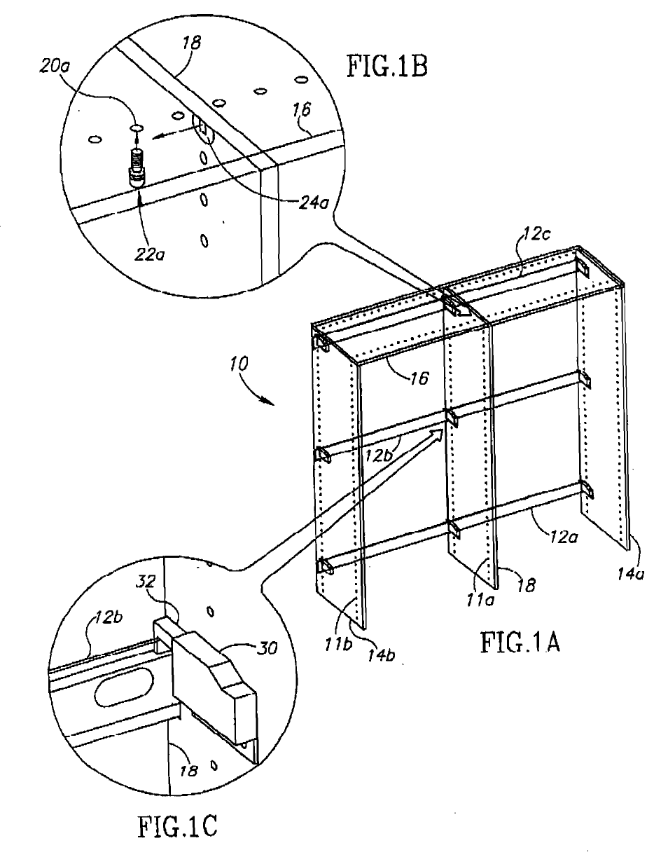

FIG. 1A is a transparent isometric view of an exemplary embodiment in the form of a storage system 10, such as an adjustable shelving system. Storage system 10 includes one or more rails attached to structural support members of a building or other support structure. For example, rails 12a, 12b, and 12c may be horizontally attached to wall studs (not shown). Objects, such as a partition 18, a drawer unit, a cabinet unit, or other object may be repositioned along the rails. A shelf (not shown) may also be coupled to a rail, and/or supported by the partition and/or side walls, such as side walls 14a and 14b. Side walls 14a and 14b may also be coupled to the rails. Alternatively, side walls 14a and 14b may be static components that are attached to the structural support members or a surface such as a wallboard (not shown). The sidewalls and/or partition may include location holes, such as location holes 11a and 11b, in which pins or other supports may be partially inserted and support a shelf or other object.

This exemplary embodiment also includes a ceiling 16, which is attached at each end to side walls 14a and 14b. The ceiling may rest on the side walls and/or be fastened, pinned, glued, or otherwise attached to the side walls. Some movable objects, such as partition 18, may be coupled to ceiling 16 to help hold an object in place while being primarily supported by the rails at a desired position between walls 14a and 14b.

As shown in FIG. 1B, a top portion of partition 18 may be coupled to ceiling 16 at a desired position to further stabilize the partition. FIG. 1B is a magnified view of an area at which partition 18 interfaces with ceiling 16. Some longitudinal position holes of ceiling 16 are shown, such as position hole 20a. A fastener, such as a screw-in dowel 22a, is partially inserted into a position hole of the ceiling at a desired partition location. A sample screw-in dowel may be a part number 6710 provided by Titus International Plc. An exposed part of the fastener is coupled to a securing component, such as a cam 24a, that is attached to the partition. In this exemplary embodiment, the securing component may be a connector with part number 06451 or 06453, provided by Titus International Plc. The securing component is tightened, or otherwise adjusted, to secure the partition to the fastener. One or more additional fasteners and securing components may be used to further secure the partition to the ceiling.

A longitudinal portion of partition 18 is coupled to one or more of the rails. FIG. 1C is a magnified view of an area at which partition 18 couples to railing 12b. A hanging bracket 30 is attached to a wide surface of partition 18 near an edge adjacent to the railing. Hanging bracket 30 includes an “L-arm” 32 that hooks over a flange of rail 12b. A sample rail 12b may be part number 875-Z1-24 provided by Peter Meier, Inc. A sample hanging bracket 30 may be part numbers 16.85450, 16.85451, or the like, provided by a supplier such as Peter Meier, Inc. Other couplers, such as a “C” clamp may be used.

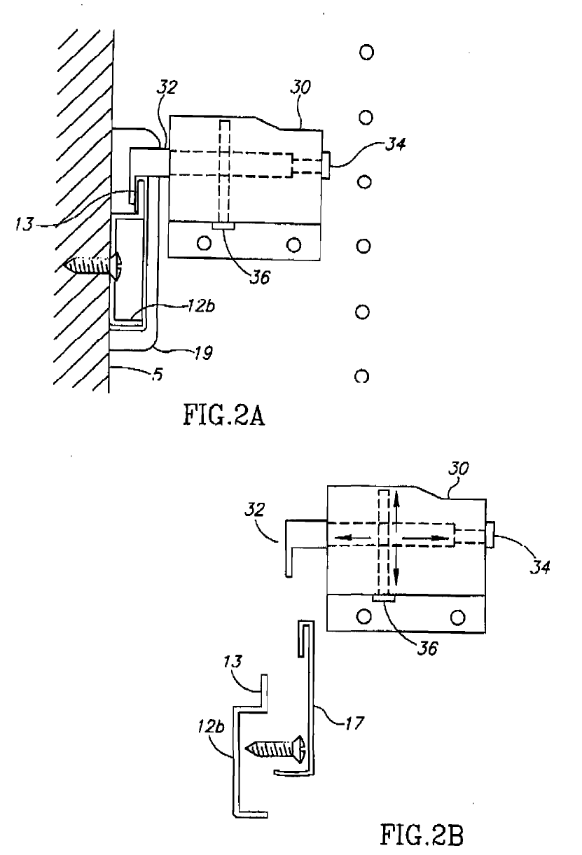

FIG. 2A is a side view of another embodiment that couples a partition to a surface such as a wall board 5. To make the partition more stable and better supported by the wall board, a notch 19 is cut out of the partition such that rail 12b can run through notch 19 and a back edge of the partition can be placed flush adjacent to wall board 5. Once L-arm 32 is in position over a flange 13 of rail 12b, a substantially horizontal adjustment 34 of hanging bracket 30 may be tightened to pull the partition toward wall board 5. This helps stabilize and/or secure the partition. Similarly, a substantially vertical adjustment 36 of hanging bracket 30 may be tightened to move the partition substantially parallel to the wall board 5 and/or to pull notch 9 toward rail 12b to further wedge the partition in position. These adjustments secure the partition in place and may utilize additional structural support of the wall board and rail. However, the adjustments also enable the partition to be loosened and repositioned. The adjustments may be arranged in other orientations, such as angled orientations, and are not limited to only vertical and horizontal orientations.

FIG. 2B is an exploded view of exemplary coupling components for further understanding. L-arm 32 extends within a housing of hanging bracket 30, where the L-arm interfaces with horizontal adjustment 34 and vertical adjustment 36. A rail cover 17 may be fitted over flange 13 of rail 12b to conceal holes in a rear attaching portion of rail 12b and/or fasteners within a channel of rail 12b that fasten rail 12b to the support element such as the wall board and/or the wall studs (not shown). L-arm 32 of hanging bracket 30 could be placed over rail cover 17 and flange 13 of rail 12b, or rail cover 17 may by cut in sections so that flange 13 may connect directly to rail 12b.

### Exemplary Embodiment—Drawer Unit

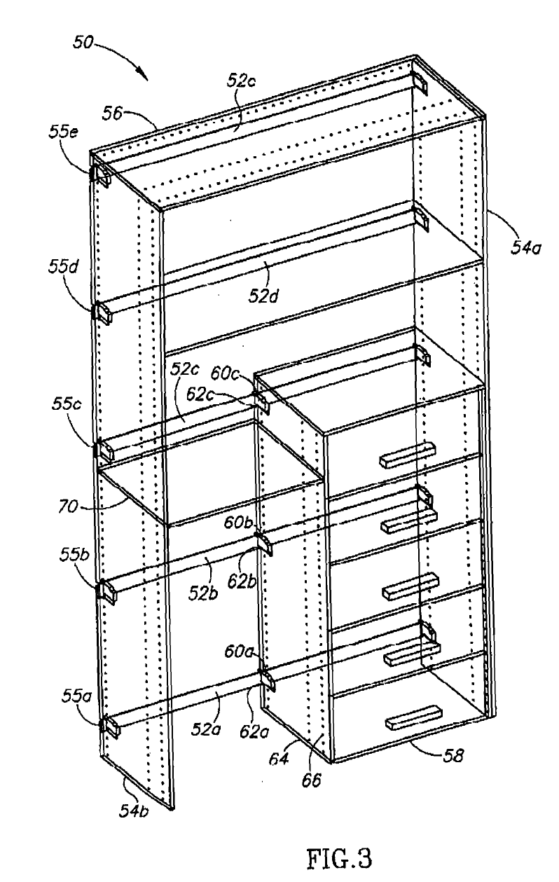

FIG. 3 is a transparent isometric view of an exemplary embodiment in the form of a storage system 50 that is coupled to structural support members of a building or other support structure with one or more rails. In this sample embodiment, rails 52a-52e are horizontally attached to wall studs (not shown). Side walls 54a and 54b may be coupled to the rails with hanging brackets, attached to a wall board, attached to wall studs, or the like. In this instance, the side walls are coupled to the rails such that a back edge of each side wall is pressed against a wall board of a building and tightened to the rails as discussed above. FIG. 3 illustrates side wall 54b coupled to rails 52a-52e with hanging brackets 55a-55e, respectively. This exemplary embodiment also includes a ceiling 56, which is attached at each longitudinal end to side walls 54a and 54b. The ceiling may rest on the side walls and/or be fastened, pinned, glued, or otherwise attached to the side walls. If desired, the storage unit may also include a back panel (not shown) between the rails and the support structure. The rails may be secured through the back panel to the support structure or to the back panel. The storage unit may then stand alone, or be secured to the support structure. Examples of modular units, design information, and production information are illustrated and discussed in U.S. patent application Ser. No. 11/110,018, filed Apr. 19, 2005, the entire contents of which are hereby incorporated by reference.

Objects, such as a drawer unit 58, a cabinet unit, or other object may be coupled to the rails and repositioned along the rails. In this embodiment, drawer unit 58 is coupled to rails 52a-52c with hanging brackets, such as hanging brackets 60a-60c. The hanging brackets may be attached to drawer unit 58 near notches, such as notches 62a-62c, in one or more side walls of the drawer unit, such as side wall 64. The notches may also help define the location at which the brackets may be fastened to the support structure, which reduces reliance on exact measurements and eases installation. The hanging brackets may also be tightened as described above to secure the drawer unit to the wall board.

The one or more side walls of the drawer unit may include one or more location holes, or sets of location holes, such as location holes 66, in which pins or other supports may be partially inserted to support a shelf, such as a shelf 70, or other object. Any shelves or other objects may be comprised of modular components that can also be coupled together horizontally, to account for differing widths as partitions, drawer units, or other objects are repositioned. For example, a shelf may comprise two components that slide relative to each other to adjust an overall length of the shelf. Alternatively, or in addition, shelves may comprise sections that include holes recessed in each end. Pins may be used to connect shelf sections together and connect the resulting shelf to holes in a partition, drawer unit, or other movable object. Other brackets may also be used to support the shelf, such as brackets that may couple to the rails.

The above specification, examples and data provide a complete description of the manufacture and use of the composition of the invention. For example, the rails may be installed at an angle to enable a storage system to be repositioned in a vertical direction as well as a horizontal position. The components discussed above may be provided in an unassembled kit for an installer or end user to assemble and/or install. Since many embodiments of the invention can be made without departing from the spirit and scope of the invention, the invention resides in the claims hereinafter appended.

What is claimed as new and desired to be protected by Letters Patent of the United States is:

1. A modular storage system comprising:
a rail including an attaching portion for attaching the rail to a support structure in a substantially horizontal orientation;
a storage component including a recess that fits over the rail such that a back portion of the storage component can be placed substantially flush with a surface of the support structure; and
an adjustable coupler coupling the storage component to the rail such that the storage component may be repositioned along the rail.

2. The modular space system of claim 1, wherein the storage component comprises one of the following; a vertical partition, a shelf, a cabinet, and a drawer unit.

3. The modular space system of claim 1, further comprising:
a first side component coupled to the rail;
a second side component coupled to the rail; and
a top component coupled to a top portion of the first side component and coupled to a top portion of the second side component, wherein the storage component is movable between the first side component and the second side component.

4. The modular space system of claim 3, further comprising at least one of the following:
a horizontal storage unit coupled between the first side component and the second side component; and
a horizontal storage unit coupled between the first side component and the storage component.

5. The modular storage system of claim 4, wherein the horizontal storage component comprises one of the following; a shelf and a dowel.

6. The modular storage system of claim 1, further comprising a rear panel to which the rail is attached and wherein the rear panel is positioned between the rail and the support structure.

7. The modular storage system of claim 1, wherein the rail includes a flange along a top edge and the adjustable coupler includes an arm that interfaces with the flange to support the storage component.

8. The modular storage system of claim 1, wherein the adjustable coupler includes at least one of the following:
a substantially horizontal adjustment that enables the storage component to be moved toward or away from the surface of the support structure; and
a substantially vertical adjustment that enables the storage component to be moved substantially parallel to the surface of the support structure.

9. The modular space system of claim 1, further comprising fasteners through the rail for fastening the rail to the support structure.

10. A method for installing a modular storage system, comprising:
attaching an attaching portion of a rail to a support structure in a substantially horizontal orientation;
fitting a recess of a storage component over the rail such that a back portion of the storage component is placed substantially flush with a surface of the support structure; and
coupling an adjustable coupler between the storage component and the rail, wherein the adjustable enables the storage component to be repositioned along the rail.

11. The method of claim 10, further comprising:
coupling a first side component to the rail;
coupling a second side component to the rail; and
coupling a top component to a top portion of the first side component and coupled to a top portion of the second side component, wherein the storage component is movable between the first side component and the second side component.

12. The method of claim 11, further comprising at least one of the following:
coupling a horizontal storage unit between the first side component and the second side component; and
coupling a horizontal storage unit between the first side component and the storage component.

13. The method of claim 10, further comprising attaching the rail to a rear panel and attaching the rear panel to the support structure.

14. The method of claim 10, further comprising at least one of the following:
adjusting a substantially horizontal adjustment of the adjustable coupler to move the storage structure toward or away from the surface of the support structure; and
adjusting a substantially vertical adjustment of the adjustable coupler to move the storage component substantially parallel to the surface of the support structure.

15. A method for providing a modular storage system kit, comprising:
providing a rail including an attaching portion for attaching the rail to a support structure in a substantially horizontal orientation; and
providing a storage component including a recess that fits over the rail such that a back portion of the storage component can be placed substantially flush with a surface of the support structure; and
providing an adjustable coupler coupling the storage component to the rail such that the storage component may be repositioned along the rail.

16. The method of claim 15, wherein the storage component comprises one of the following; a vertical partition, a shelf, a cabinet, and a drawer unit.

17. The method of claim 15, further comprising:
providing a first side component for coupling to the rail;
providing a second side component for coupling to the rail; and
providing a top component for coupling to a top portion of the first side component and to a top portion of the second side component, such that the storage component will be movable between the first side component and the second side component.

18. The method of claim 17, further comprising at least one of the following:
providing a horizontal storage unit for coupling between the first side component and the second side component; and
providing a horizontal storage unit for coupling between the first side component and the storage component.

19. The method of claim 18, wherein the horizontal storage component comprises one of the following; a shelf and a dowel.

20. The method of claim 15, further comprising providing a rear panel for attaching between the rail and the support structure.
